(19) United States
(12) Patent Application Publication
(10) Pub. No.: US 2010/0319043 A1
(43) Pub. Date: Dec. 16, 2010

(54) INTERACTIVE TELEVISION ARCHITECTURE

(75) Inventors: Kamal Jain, Bellevue, WA (US); Danah Michele Boyd, Boston, MA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/482,476

(22) Filed: Jun. 11, 2009

(51) Int. Cl. H04N 7/173; G06F 3/033; H04N 5/44

(52) U.S. Cl. 725/110; 725/133; 345/157; 348/734; 348/E05.096

(57) ABSTRACT

A set top box that is placed in communication with a television is described herein and includes a receiver component that receives viewer-generated data from a portable electronic device, wherein the viewer-generated data is provided by a viewer responsive to display of interactive television content viewed by the viewer on the television. The set top box also includes a transmission component that transmits the viewer-generated data to a data repository managed by a third party service provider and a display component that causes interactive data pertaining to the viewer-generated data to be overlaid on the television content viewed by the viewer on the television.

### BACKGROUND

Televisions are commonplace in homes today, and are used by many as a primary form of entertainment. Currently, televisions receive audio-video signals by a limited number of means. Specifically, a television can receive television signals by way of a cable connection, a satellite connection, or through use of an antenna to capture over-the-air signals. In many cases, to display television signals through these means requires a set top box or other peripheral. For example, a digital signal can be provided to a set top box by way of any suitable communications technology, and the set top box can be configured to process the digital signal such that images can be displayed on the television. Further, many set top boxes are equipped with high definition tuners that allow an HD-ready television to display television signals in high definition.

These set top boxes can also provide other functionality, such as the ability to record a program without use of a tape or DVD, and allow the viewer to view the program at the viewer convenience of the viewer. Furthermore, some set top boxes allow viewers to pause and/or rewind live television signals, such that the viewer does not miss a particular portion of a television program, for example, when the viewer receives a phone call. Still further, the set top box may include functionality that allows the viewer to set recording times for programs of interest to the viewer in the future by simply pressing a button. For example, the viewer can cause a program guide to be graphically presented to the viewer on the television and may scroll through the guide to locate and select a program that is to be aired in the future. By pressing a single button, the viewer can cause the set top box to be programmed to record the selected program.

All these advances in television technologies have made the television viewing experience more enjoyable for viewers. Such technologies, however, do not allow for interactive communication between a viewer and a program provider. One reason for this lack of interactivity is that altering an infrastructure for providing the ability to interact with television programming is an expensive proposition. Specifically, conventional infrastructure for delivering television signals to viewers is one-way in nature. That is, television signals can be provided or transmitted to the television, but nothing can be transmitted back along such a communications channel. Because of significant costs in connection with allowing for interactive technologies in television, there has been little demand for interactive television functionality.

### SUMMARY

The following is a brief summary of subject matter that is described in greater detail herein. This summary is not intended to be limiting as to the scope of the claims.

Described herein are various technologies pertaining to interactive television. In an example, interactive television can be realized through utilization of a set top box that is in communication with a television. A third party service provider can be in communication with the set top box, and the third party service provider can also be in communication with a broadcaster of television signals. When a viewer turns on a television, the set top box can assign a coordinate system to such television. Furthermore, the set top box can cause a graphical pointer to be displayed on the television screen based upon viewer interaction with, for instance, an air mouse. Moreover, the set top box can be synchronized with programming provided by the broadcaster.

When an interactive television program is displayed on the television of the viewer (e.g., a television program that graphically depicts choices to a viewer), the viewer can employ the air mouse to position the graphical pointer over one of the choices presented in the television program. Through use of the air mouse, the viewer can indicate selection of one of the choices presented to the viewer. For instance, the viewer can depress a particular button on the air mouse. When the set top box receives an indication of a selection, coordinates of the graphical pointer during the selection can be saved together with a time stamp corresponding to the selection and a channel being viewed by the viewer. This information can be transmitted to the third party service provider, which can ascertain which of the displayed options the viewer has selected. The third party service provider may then transmit display data to the set top box, wherein the display data corresponds to the options presented on the television. In an example, if a viewer is watching a quiz show, the viewer can select one of a plurality of possible answers presented by the television program through use of the air mouse. This selection can be transmitted to the third party service provider, which can ascertain which selection was made by the viewer. The third party service provider may then provide the set top box with image data that indicates how many viewers or what percentage of viewers selected the different options, thereby allowing the viewer to more fully participate in the quiz show.

While the above example has been described with respect to a set top box and an air mouse, it is to be understood that other forms of communication with the third party service provider are contemplated. In an example, a viewer may download an interactive television application to a portable electronic device such as a portable telephone. Such application may cause buttons of the portable electronic device to perform certain actions that pertain to interactive television. For instance, the viewer may indicate through use of the downloaded application which television program they are currently watching. In an example, if the television is a quiz show that provides a plurality of possible answers for a particular question, then the downloaded application may assign a plurality of buttons to correspond with the plurality of possible choices. When the viewer depresses a button or performs a task that corresponds to an interactive television program, interactive data can be transmitted from the portable electronic device to the third party service provider. The third party service provider can receive the interactive data from the viewer, together with an identity of a program being viewed by the viewer and time stamp corresponding to the interactive data, and can determine an interactive function undertaken by the viewer. The third party service provider may then output display data that can be displayed to the viewer on the portable electronic device.

Other aspects will be appreciated upon reading and understanding the attached figures and description.

### BRIEF DESCRIPTION OF THE DRAWINGS

FIG. 1 is a functional block diagram of an example system that facilitates providing a viewer with interactive television.

FIG. 2 is a functional block diagram of an example system that depicts a viewer selecting an option in an interactive television program.

FIG. 3 is a functional block diagram of an example system that illustrates image data provided to a television based upon interactive data proffered by a viewer.

FIG. 4 is a functional block diagram of an example set top box.

FIG. 5 is a functional block diagram of an example system that facilitates providing a viewer with interactive television functionality.

FIG. 6 is a functional block diagram of an example system that facilitates providing a viewer with interactive television content using a mobile phone.

FIG. 7 is a functional block diagram of a mobile phone that shows interactive content to a viewer.

FIG. 8 is a flow diagram illustrating an example methodology for providing interactive television content to a viewer.

FIG. 9 is a flow diagram illustrating an example methodology for providing interactive television content to a viewer.

FIG. 10 is a flow diagram illustrating an example methodology for using a third party service to provide interactive television functionality to a viewer.

FIG. 11 is an example computing system.

### DETAILED DESCRIPTION

Various technologies pertaining to interactive television will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

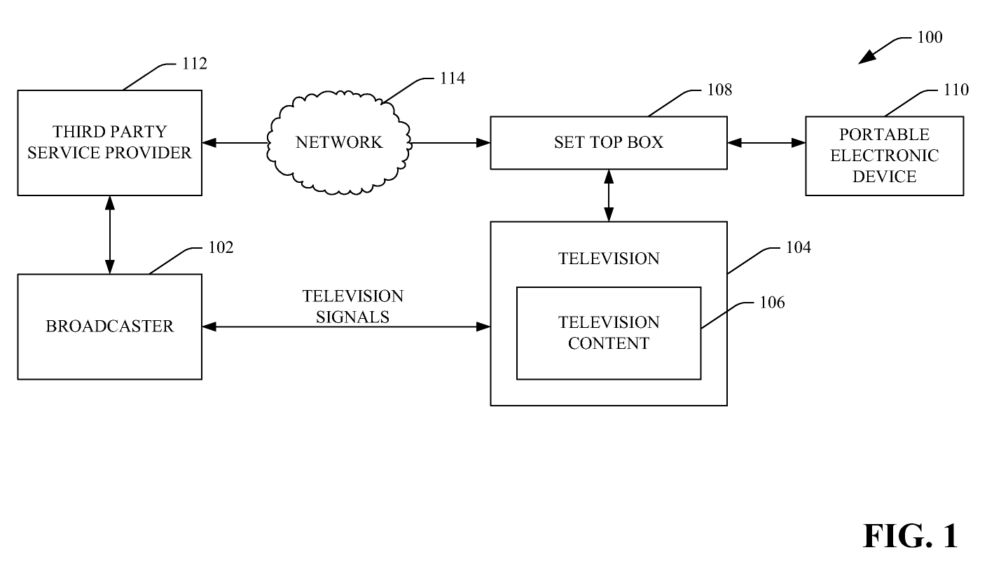

With reference to FIG. 1, an example system 100 that facilitates provision of interactive television functionality to a television viewer is illustrated. The system 100 includes a broadcaster 102 that broadcasts television signals. The broadcaster 102 may also be referred to as a television network, etc. A television 104 receives television signals broadcast by the broadcaster 102 and displays television content 106 to a viewer based upon the television signals received from the broadcaster 102. The television 104 can receive the broadcast television signal by any suitable means. For example, the television signal can be received at the television 104 by way of a coaxial cable, by way of a satellite television connection, over the air through use of an antenna, etc.

The system 100 may additionally include a set top box 108 that is in communication with the television 104. While the television 104 is shown as directly receiving television signals from the broadcaster 102, in another embodiment the set top box 108 can be configured to receive the television signals from the broadcaster 102 and can process such signals such that the television content 106 can be displayed in a suitable manner on the television 104. For example, a coaxial cable can be provided as input to the set top box 108 from a cable provider. The set top box 108 may process signals received from the cable provider, and output processed signals to the television 104 by way of any suitable connection, including but not limited to coaxial cable, component video cable, S-video cable, VGA connection, composite video, etc.

A portable electronic device 110 may be in communication with the set top box 108, and when operating in conjunction therewith can cause a graphical pointer to be displayed on the television content 106. For example, the portable electronic device 110 may be an air mouse or other suitable mechanism. In an example, the air mouse may be or may be included in a remote control that is configured for use in connection with the set top box 108. Furthermore, the portable electronic device 110 may be in wireless communication with the set top box 108.

In operation, when the set top box 108 is placed in communication with the television 104, the set top box 108 can generate a coordinate system for a screen of the television 104. In an example, a bottom left hand corner of a screen of the television 104 can be assigned coordinate 0,0 and an upper right corner of a screen of the television 104 can be assigned coordinate 500,500. When the television 104 displays the television content 106, the set top box 108 can cause a graphical pointer to be displayed over such television content 106 responsive to receipt of location information from the portable electronic device 110. Therefore, if television content 106 includes a plurality of selectable options (e.g., such as possible answers to a trivia question), the set top box 108 can cause the graphical pointer to be positioned over one of such choices if the viewer positions the portable electronic device 110 appropriately.

The viewer may then use the portable electronic device 110 to select one of the choices presented to the viewer in the television content 106. Specifically, the viewer can use the portable electronic device 110 to position the pointer over a desired choice in the television content 106, and then cause the portable electronic device 110 to output an indication that the viewer has made a selection of such choice. For instance, the portable electronic device 110 may include a button that is used by the viewer to indicate that the viewer has selected a choice.

The set top box 108, upon receipt of such indication from the portable electronic device 110, can generate a time stamp, determine a coordinate location of the graphical pointer when the indication of selection from the portable electronic device 110 was received, and can determine a channel being viewed by the viewer of the television 104 (or program being viewed by the viewer), and can generate an interactive data packet including such information.

A third party service provider 112 can be in communication with the set top box 108 by way of a network 114. In an example, the set top box 108 may be an Internet-capable device and may be in communication with the third party service provider 112 by way of an Internet connection. The set top box 108 can transmit the generated interactive data packet to the third party service provider 112 by way of the network 114. Upon receipt of such interactive data packet, the third party service provider 112 can determine which of the choices presented to the viewer in the television content 106 was selected by such viewer. Specifically, given coordinates on the television content 106, channel or program being viewed by the viewer, and time of a selection by a viewer, the third party service provider 112 can determine which choice was selected by the viewer.

The third party service provider 112 may then transmit image data pertaining to the selected choice to the set top box 108. The set top box 108 may then cause the image data pertaining to the viewer selection of the choice to be displayed on the television content 106. Allowing the viewer to interact with a television program and providing such viewer with content pertaining to such interaction can greatly enrich a viewing experience of the viewer. Furthermore, the third party service provider 112 may be in communication with numerous set top boxes. Thus, the viewer can be provided with image data pertaining to choices or interactions with the television content of other viewers. The third party service provider 112 may optionally be in communication with the broadcaster 102, such that the broadcaster 102 can choose to transmit television signals that take into consideration interactive data of a plurality of viewers.

As noted above, the set top box 108 may be configured to be connected to the Internet and may be configured to execute functions/applications that can be downloaded by way of the Internet. Furthermore, the set top box 108 can be used in connection with social networking among viewers to watch the interactive television content collaboratively with another viewer in another location. The set top box 108 can be configured to receive image data pertaining to interactive content of the viewer, as well as interactive content of friends of the viewer to create collaborative information. The set top box 108 may then display such collaborative information over the television content 106.

Furthermore, the set top box 108 may be configured to be included in any suitable hardware device. For example, functionality of the set top box 108 may be incorporated into the television 104. In another example, the set top box 108 may be included in a gaming console. Furthermore, the set top box 108 could be used to stream content from the Internet and display or present such content on the television 104. For instance, the set top box 108 can be programmed with an application that receives streaming music and causes such music to be presented on the television 104.

Still further, the set top box 108 can be configured with an application that causes interactive television responses from the viewer and data pertaining thereto to be posted on a social networking website of the viewer. For example, if the viewer is watching a television quiz show and answers questions presented in the television content 106 by way of the portable electronic device 110 and the set top box 108, the set top box 108 can be configured with an application that causes an identity of the program being viewed by the viewer and viewer selection of quiz show answers to be posted to the social networking website of the viewer. Thus, individuals in a social network of the viewer can be provided with information pertaining to the viewing habits of the viewer and/or performance with respect to the television quiz show.

With respect to the third party service provider 112, such service provider 112 may be affiliated with the broadcaster 102 or may be an independent agency. The third party service provider 112 may use multiple servers in connection with monitoring interactive television activity with respect to a plurality of viewers at any one point in time. The third party service provider 112 can generate statistics pertaining to interactive television content based on a variety of factors, such as but not limited to gender, age, location, etc., of viewers. For instance, the third party service provider 112 can cause image data to be transmitted to the set top box 108 that causes statistics regarding quiz show questions to be displayed with respect to a gender and/or age of the viewer. Still further, the set top box 108 can be configured with various television functionalities such as the ability to buffer television content, to rewind, fast forward and record television content, schedule future recordings of television programs from remote locations, etc.

In another embodiment, the set top box 108 can be configured to analyze actions of the user directly, wherein the user does not utilize the air mouse 110. For instance, the set top box 108 can be configured with a camera or associated with a camera that can recognize gestures of the user. Based at least in part upon a recognized gesture, the set top box 108 can transmit data to the third party service provider 112 that indicates a selection of a choice of the user. In another example, the set top box 108 can be configured with speech recognition hardware and/or software. The user can audibly output a selection of certain content displayed on the television 104, and the set top box 108 can interpret such audible output and transmit a selection of the user to the third party service provider 112.

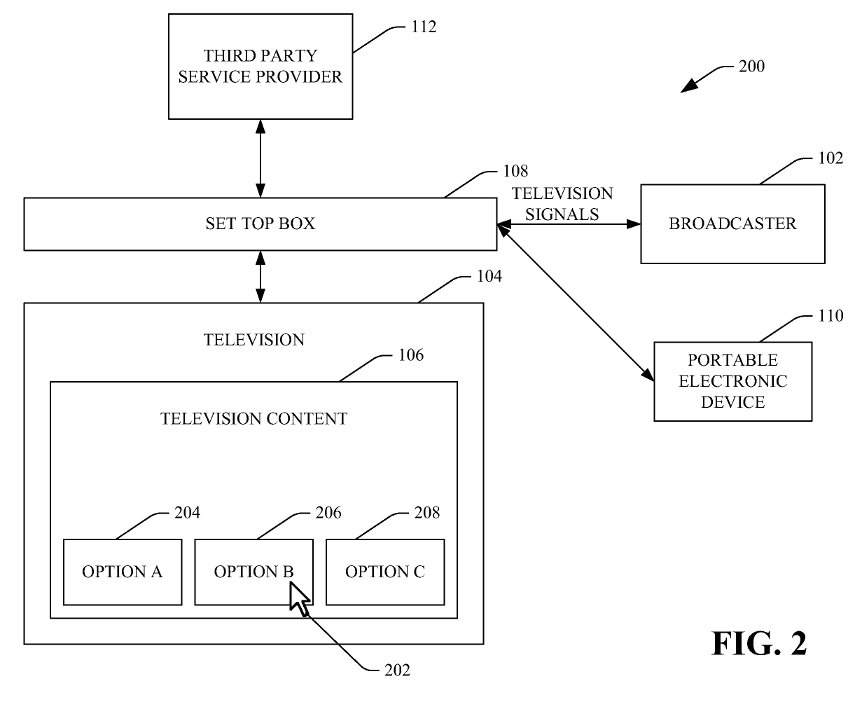

Turning now to FIG. 2, an example system 200 that facilitates providing interactive television functionality when a television signal is provided by way of a one-way channel is illustrated. The system 200 includes the broadcaster 102 that broadcasts television signals. The set top box 108 in this example is configured to receive the television signals transmitted by the broadcaster 102. For example, the set top box 108 can receive a coaxial cable line as input, and may receive television signals output by the broadcaster 102 by way of a cable provider. The television 104 is in communication with the set top box 108 such that the set top box 108 can cause the television 104 to display the television content 106 in a suitable manner.

The portable electronic device 110 is in communication with the set top box 108 and can cause a graphical pointer 202 to be positioned at a certain location over the television content 106. Pursuant to an example, the set top box 108 can receive the television signal and can receive an indication of desired location of the graphical pointer 202 on the television screen by way of viewer interaction with the portable electronic device 110. The set top box 108 can process such signals and cause the graphical pointer 202 to be overlaid on the television content 106.

In the example depicted in FIG. 2, the television content 106 pertains to a trivia show, wherein a question is asked from a host, and a plurality of options are graphically depicted so that viewers of the television program can review such options. In this example, the television content 106 depicts an Option A 204, an Option B 206, and an Option C 208. Through use of the portable electronic device 110 the viewer of the television program can cause the graphical pointer 202 to be positioned over the depicted Option B 206. Depressing a certain button on the portable electronic device 110, for example, can cause the set top box 108 to ascertain that the viewer of the program wishes to interact with the television content 106 being presented to the viewer. The set top box 108 can capture a location of the graphical pointer 202 when the button is depressed, and determine a current channel (or program) being viewed by the viewer, and can assign a time stamp indicating when the button was depressed. The set top box 108 may then create an interactive data packet that includes the determined location of the selection, the time stamp, and channel (or program) being viewed by the viewer, and can cause such interactive data packet to be transmitted to the third party service provider 112.

The third party service provider 112 can review this interactive data packet and, based upon the content of the data packet, can determine which of the options was selected by the viewer. It can be ascertained that the set top box 108 transmits a relatively small amount of data when the data packet is transmitted to the third party service provider 112. Thus, the viewer need not have a high speed Internet connection to receive/use interactive capabilities with respect to the television content 106.

While the example described above pertains to a quiz show with graphical options presented, it is to be understood that other forms of interactivity with respect to television are contemplated. For example, advertisers may find such system 200 to be beneficial in generating advertising and/or causing viewers to carefully watch advertisements. For example, an advertiser may decide to provide viewer benefits for viewer interactivity with one of their advertisements. In an example, an advertiser may provide viewers with coupons if viewers interact with the advertisements (and thus carefully pay attention to advertising content). Other interactive television programming is also contemplated and intended to fall under the scope of the hereto appended claims.

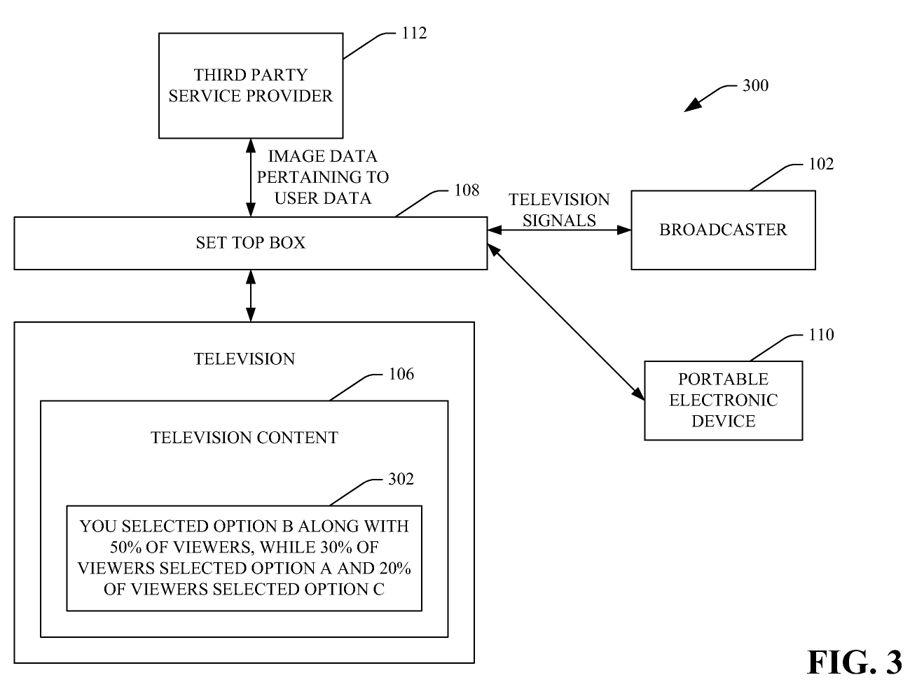

Turning now to FIG. 3, an example system 300 that facilitates provision of image data to a viewer of a television is illustrated. The system 300 includes the broadcaster 102, the television 104, the set top box 108, the portable electronic device 110, and the third party service provider 112, which are in communication as described above. In the example depicted in FIG. 3, the third party service provider 112 has received interactive data from a viewer of the television content 106 displayed to the viewer on the television 104 by way of the set top box 108. As described above, the third party service provider 112 can determine a choice selected by the viewer of the television content 106 based among a position of a graphical pointer when a choice was selected by the viewer, and a time stamp indicating when such selection was made. For example, the third party service provider 112 can be synchronized with the broadcaster 102 and can further be synchronized with the set top box 108. Such synchronization may be accomplished through any suitable mechanism. For example, the broadcaster 102 can transmit a synchronization signal in a television signal, and such synchronization signal can be used to synchronize the set top box 108 and the third party service provider 112 with broadcast content.

Upon determining which choice the viewer has made (and which choices a plurality of other viewers have made), the third party service provider 112 can cause image data pertaining to the interactive data provided by the viewer to be transmitted to the set top box 108. This image data may include textual data, graphical images, etc. The image data can include details pertaining to which option the viewer selected, which option a friend of the viewer selected, which option a plurality of other viewers selected, which option a certain segment of viewers selected, etc.

The set top box 108 can process the image data together with television signals received from the broadcaster 102. The set top box 108 may cause the image data received from the third party service provider 112 to be overlaid on the television signals received from the broadcaster 102. Thus, the set top box 108 may cause or enable the television 104 to display the television content 106 with the image data 302 overlaid thereon. In the example shown in FIG. 3, the image data 302 informs the viewer that the viewer selected Option B (See FIG. 2) together with 50 percent of overall viewers, while 30 percent of viewers selected Option A and 20 percent of viewers selected Option C. Thus, the image data 302 shows the viewer the selection of the viewer as compared to selections by other viewers of the television content 106. As noted above, however, the image data 302 may indicate that the viewer selected Option B while the friend of the viewer selected Option C. Thus, the viewer may essentially watch and interact with television content with a friend that is a great distance from the viewer. Furthermore, the image data 302 may inform the viewer of how a certain segment of viewers interacted with the television content 106. For instance, the viewer may wish to be informed of how other viewers proximate to the age of the viewer interacted with the television content 106.

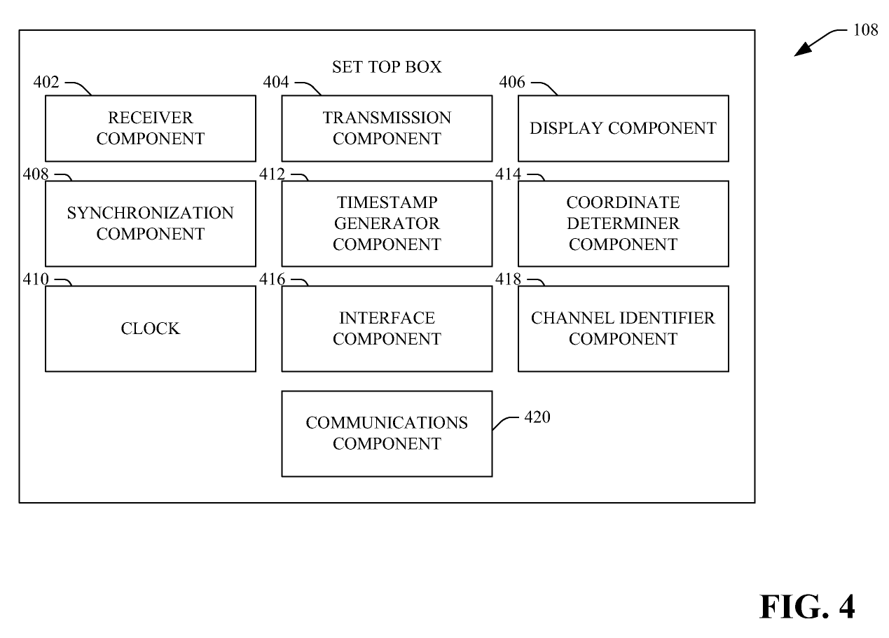

With reference now to FIG. 4, a functional block diagram of the set top box 108 is illustrated. While the set top box 108 is shown as including a plurality of different components, functionality corresponding to these components may be combined into more or fewer components. Furthermore, the set top box 108 may be configured to perform other functionality that is not described herein. The set top box 108 includes a receiver component 402 that is configured to receive viewer generated interactive data from a portable electronic device. For example, the viewer generated interactive data can be provided by a viewer responsive to the viewer being provided with interactive television content. In an example, the receiver component 402 may be an antenna or other suitable mechanism that is configured to receive wireless signals from a portable electronic device such as infrared signals, Bluetooth signals, etc.

A transmission component 404 can be configured to transmit the viewer-generated interactive data received by the receiver component 402 to a third party service provider (e.g., to a data repository managed by the third party service provider). In an example, the transmission component 404 may be configured to transmit the viewer-generated interactive data by way of an Internet connection (modem, cable, etc.). As noted above, the third party service provider can output image data pertaining to the viewer-generated interactive data. A display component 406 can be configured to display image data received from the third party service provider that pertains to the viewer-generated interactive data. In an example, the display component 406 can overlay such image data on television content viewed by the viewer of the television.

The set top box 108 may also include a synchronization component 408 that is configured to synchronize a clock 410 in the set top box 108 with a clock corresponding to television content received by the set top box 108. For example, a broadcaster can output a synchronization signal that can be received by the synchronization component 408 and, responsive to receipt of such synchronization signal, the synchronization component 408 can set the clock 410. In another example, the synchronization component 408 may receive a synchronization signal from the third party service provider, and the synchronization component 408 can set the clock 410 based at least in part on the received synchronization signal. In still yet another example, the synchronization component 408 can be configured to perform some form of handshaking between the set top box 108 and the third party service provider and/or the broadcaster.

A time stamp generator component 412 can be in communication with the clock 410 and can generate a time stamp responsive to the receiver component 402 receiving viewer-generated interactive data. The time stamp generator component 412 may also be configured to assign the time stamp to the viewer-generated interactive data received by the receiver component 402. The transmission component 404 can be configured to transmit the viewer-generated interactive data together with the time stamp generated by the time stamp generator component 412 to the third party service provider. Thus, for instance, the third party service provider can be provided with data that is indicative of which of a plurality of choices was selected by the viewer, and what time such selection was made.

The set top box 108 may also comprise a coordinate determiner component 414 that can determine coordinates on a television screen where the viewer selected an option presented in the television content (e.g., a possible answer to a trivia question presented in television programming). For example, when the set top box 108 is placed in communication with the television, the set top box can be configured to assign a coordinate system to the television screen. The coordinate determiner component 414 can ascertain where a graphical pointer is positioned on the television screen when the selection of a choice presented on such screen is received by the receiver component 402. As described above, such selection may be made through depression of a button on an air mouse.

The set top box 108 may also include an interface component 416 that is configured to receive television audio-video input and overlay image data upon the received audio-video input. For instance, the interface component 416 can be configured to receive television audio-video input by way of any suitable audio-video connection, including but not limited to S-video cable, a coaxial cable, a satellite signal, AVG cables, an antenna signal, component cables, etc. As described above, the set top box 108 can receive image data pertaining to the viewer-generated interactive data from a third party service provider. The interface component 416 can receive television signals by way of any suitable communications medium. The interface component 416 can process the received image data from the third party service provider and the television audio-video signals received from a television provider, and can cause the image data to overlay portions of the television audio-video signals. The display component 406 may then display the television content with the image data overlaid thereon.

A channel identifier component 418 may be included in the set top box 108 and may be configured to identify a channel or program being viewed on a television in communication with the set top box 108. Thus, the set top box 108 may be in communication with a television signal provider and can ascertain a channel being viewed by the viewer based at least in part upon data provided by the television service provider. In another example, the channel identifier component 416 may be configured to identify a program being viewed by the viewer.

The set top box 108 may also include a communications component 420 that allows the viewer to interact with television content with a specifically-identified viewer or set of viewers (e.g., identified by the viewer). Thus, the viewer may select a friend, a family member, a group of friends, etc., with whom the viewer wishes to interactively watch television content. For example, the viewer may wish to play an interactive trivia game via the television with a certain friend. The viewer can use the communications component 420 to identify such friend (e.g., by user name, IP address, etc.). The communications component 420 may then be configured to receive viewer-generated interactive data from a second viewer watching the television content on a different television in a different location. The display component 406 can be configured to overlay this data received from the second viewer based at least in part upon viewer-generated interactive data from the second viewer.

Continuing with the trivia show example, the first viewer may select a first possible trivia answer for a presented trivia question while the second viewer may select a second possible answer to the presented trivia question. The communications component 420 can be configured to receive image data pertaining to the choice selected by the second viewer, and the display component 406 can display image data pertaining to such choice selected by the second viewer. Therefore, if the first viewer selected the first option and the second viewer elected the second option, the display component 406 can display image data to the first viewer indicating that the second viewer selected an option different from the option selected by the first viewer.

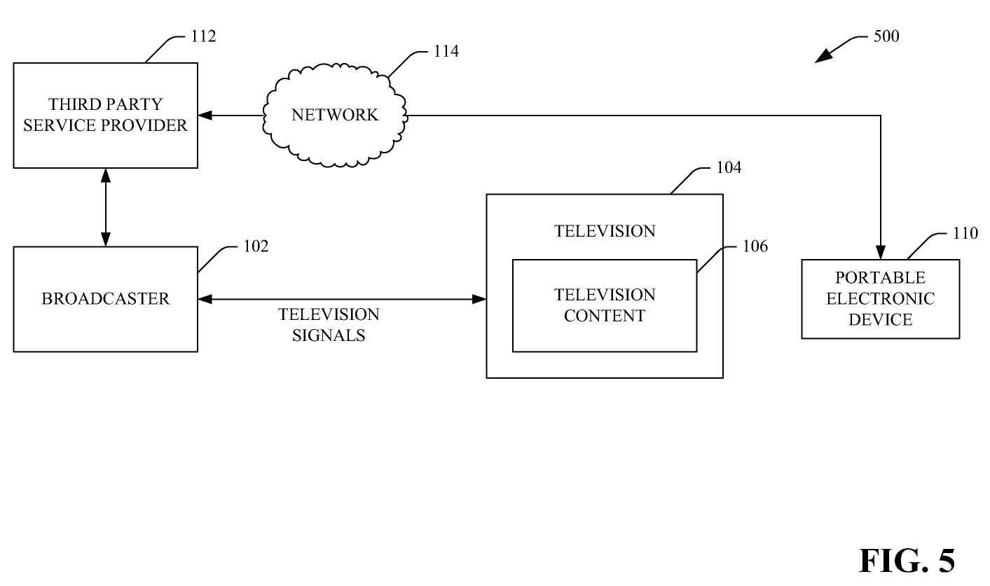

Referring now to FIG. 5, an example system 500 that facilitates provision of interactive television component to a viewer is illustrated. The system 500 includes the broadcaster 102 which broadcasts the television signals. The television 104 receives such signals and displays the television content 106 based at least in part upon the television signals. A viewer of the television content 106 uses the portable electronic device 110 to interact with such content. In the example system 500 it is to be noted that the portable electronic device 110 communicates with the third party service provider 112 by way of a network 114 and without having a set top box as an intermediate device. For example, the viewer may wish not to purchase a set top box for purposes of interacting with the television content 106, but may still wish to interact with such television content 106.

In an example, the portable electronic device 110 may be a mobile telephone that has an interactive television application executing thereon. For instance, the viewer may download an interactive television application and install such application on the portable electronic device 110. The application may cause certain buttons of the portable electronic device 110 to be used in connection with interactive viewing of the television content 106. For example, depression of a first button on a portable electronic device 110 may cause a first option displayed in the television content 106 to be selected by the viewer. Such selection can be transmitted from the portable electronic device 110 to the third party service provider 112 by way of the network 114.

The third party service provider 112 may transmit image data pertaining to the interactive content provided by the viewer to the portable electronic device 110, which may then display at least a portion of the image data to the viewer on a display screen of the portable electronic device 110. Additionally, the third party service provider 112 can cause interactive data to be transmitted to the broadcaster 102, wherein such interactive data may indicate a number of viewers that have interacted with the television content 106 in different ways. For instance, interactive content transmitted to the broadcaster 102 from the third party service provider 112 can indicate how many viewers selected certain options presented in the television content 106. The broadcaster 102 may then choose to display images in the television content 106 based at least in part upon the information provided by the third party service provider 112. Therefore, using the system 500, the viewer can interact with the television content 106 without use of a set top box.

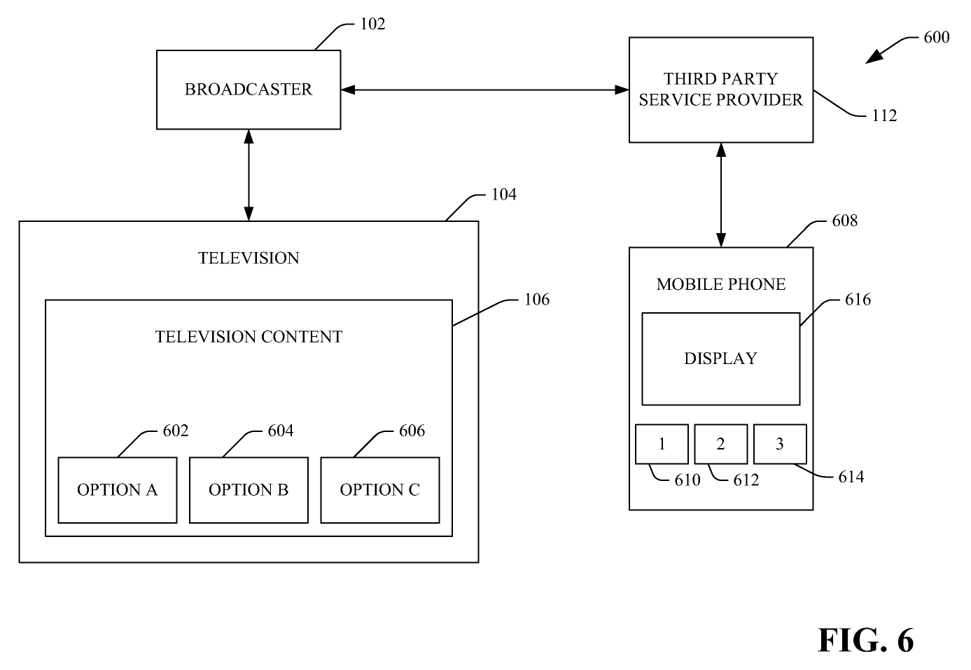

With reference now to FIG. 6, an example system 600 that facilitates provision of interactive television content to a viewer is illustrated. The system 600 includes the broadcaster 102 that broadcasts television signals that are received and displayed as the television content 106 by the television 104. In this example, television content 106 displays a plurality of options: Option A 602, Option B 604, and Option C 606. For example, the television content 106 may include graphical and/or audio description of a trivia question, and the television content 106 may include graphical and/or audio indication of three possible answers (options) for the trivia question, wherein the possible answers are Option A 602, Option B 604, and Option C 606. A viewer may be watching television content 106 and may wish to interact with such content.

The viewer may have a mobile phone 608 that has an interactive television application executing thereon. The interactive television application may be configured to assign certain functionality to particular buttons on the mobile phone 608. In an example, the mobile phone 608 may comprise at least three depressible buttons: depressible button 610, depressible button 612, and depressible button 614. For instance, the button 610 may correspond to a first option depicted in the television content 106 (e.g., Option A 602). The second button 612 may correspond to a second option depicted in the television content 106 (e.g., Option B 604). The third button 614 may correspond to a third option depicted in the television content 106 (e.g., Option C 606). Furthermore, the viewer may provide through use of the mobile phone 608 an indication of a channel that is being viewed and/or an indication of a television program that is being viewed by the viewer. For instance, the interactive television application executing on the mobile phone 608 may request information pertaining to which channel is being viewed by the viewer and/or which program is being viewed by the viewer. The mobile phone 608 includes a display 616 that can display such requests to the viewer, and the viewer may utilize the mobile phone 608 to indicate which channel/program is being viewed by the viewer. Furthermore, the interactive television application executing on the mobile phone 608 may cause the mobile phone 608 to be synchronized with the third party service provider 112 and/or the broadcaster 102.

In an example operation of the system 600, the viewer may watch the television content 106 and may use the mobile phone 608 to interact with the television content 106. For instance, the viewer may wish to select an answer corresponding to Option B 604 with respect to a trivia question presented in the television content 106. The viewer may depress the second button 612, and the mobile phone 608 can cause data pertaining to depression of the second button 612 to be transmitted to the third party service provider 112. For example, the mobile phone 608 can transmit an indication that the viewer has depressed the second button 612 together with data that identifies a program or channel being viewed by the viewer and a time stamp indicating when the viewer selected the second button 612. The third party service provider 112 can analyze the data provided by the mobile phone 608 and can determine that the viewer has selected Option B 604 in the television content 106. The third party service provider 112 may then transmit such information to the broadcaster 102, which may choose to display data pertaining to viewer selections in the television content 106. Additionally, as will be described below, the third party service provider 112 can generate image data to be displayed on the display 616 of the mobile phone 608 pertaining to the selection of Option B 604 in the television content 106 by the viewer.

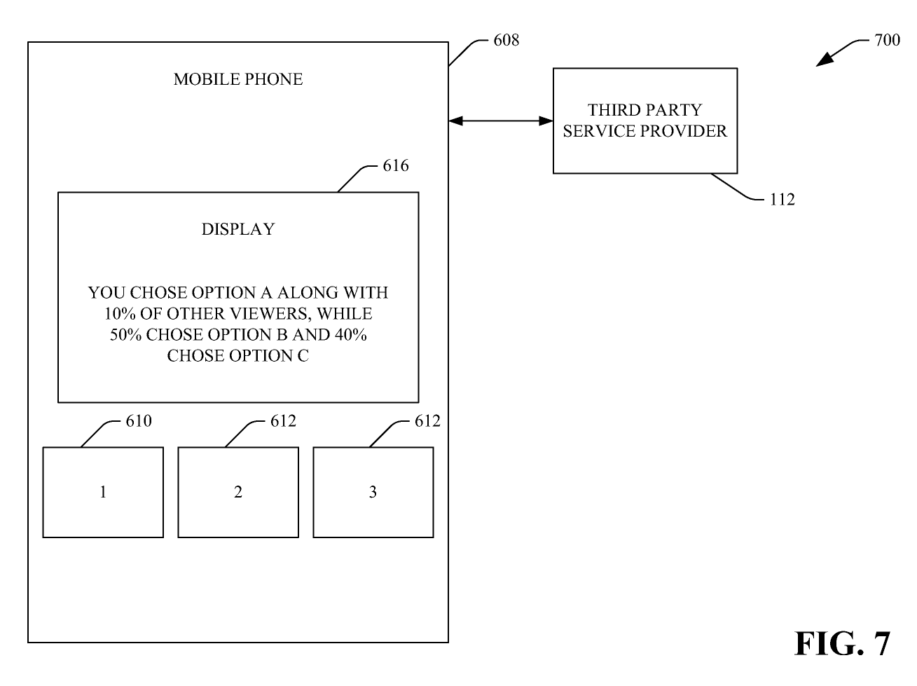

Turning now to FIG. 7, an example system 700 that facilitates display of image data pertaining to viewer-generated interactive data with respect to television signals is illustrated. The system 700 includes the mobile phone 608 that is in communication with the third party service provider 112. The third party service provider 112, as noted above, can generate image data pertaining to the viewer-generated interactive data provided by the viewer through use of the mobile phone 608. Continuing with the example described with respect to FIG. 6, the viewer may use the mobile phone 608 to indicate to the third party service provider 112 that the viewer wishes to interact with television content by selecting Option B 604 presented in the television content 106 (see FIG. 6).

Responsive to receipt of such information (and/or interactive data from other viewers), the third party service provider 112 can generate and transmit image data to be displayed on the display 616 of the mobile phone 608. As shown, the image data displayed on the display 616 of the mobile phone 608 can inform the viewer that the viewer has selected Option B 604 along with 10 percent of other viewers, while 50 percent of viewers chose Option A 602 and 40 percent chose Option C 606. As described above, the interactive television application executing on the mobile phone 608 may also be employed by the viewer to identify particular viewers, wherein the viewer wishes to have knowledge of interactive data of the particular viewers. For example, the viewer may indicate that she wishes to view a trivia game broadcast by the broadcaster 102 interactively with a certain friend. The third party service provider 112 may then generate image data pertaining to activity of the selected friend. For example, the image data can cause the display 616 to display an indication that the friend of the viewer selected Option C while the viewer selected Option B. Moreover, the interactive television application executing on the mobile phone 608 can automatically/semi-automatically transmit interactive television data to a social networking website, for example, to update a profile of the viewer.

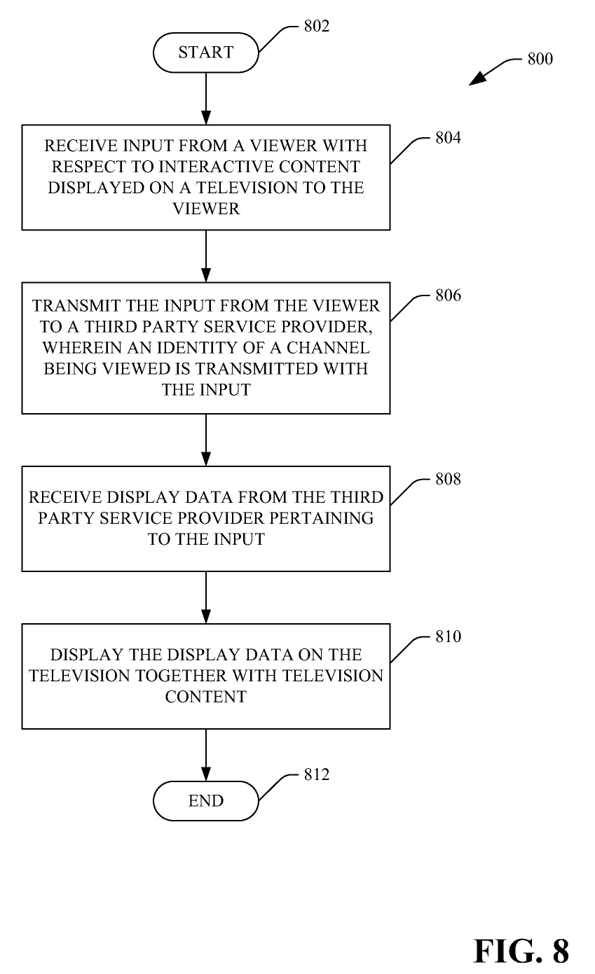

With reference now to FIGS. 8-10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore in some instances, not all acts may be required to implement a methodology described herein.

Moreover, the acts described herein may be computer executable instructions that can be implemented by one or more processors and/or stored on a computer readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 8, a methodology 800 that facilitates provision of interactive television content is illustrated. The methodology 800 begins at 802, and at 804 input is received from a viewer with respect to interactive content displayed on a television and being viewed by the viewer. For example, the methodology 800 may be implemented in a set top box, and the received input may be by way of an air mouse that operates in connection with the television by way of the set top box. It is to be understood, however, that the received input may be received from any suitable portable electronic device.

At 806, the input from the viewer is transmitted to a third party service provider. In an example, the input from the viewer may be transmitted to the third party service provider together with an identity of a channel being viewed by the viewer (e.g., a channel to which the television is currently tuned). The identity of the channel can be ascertained from explicit viewer input, can be ascertained based upon analysis of a set top box or signal, etc. Furthermore, the input from the viewer can be transmitted together with a time stamp that indicates when in time the input from the viewer was received (e.g., when the viewer made an interactive selection with respect to television content). In yet another example, the input can be transmitted together with coordinates of an air mouse displayed on a television when the viewer made a selection of an option being displayed/described in the television content.

At 808, display data is received from the third party service provider pertaining to the input from the viewer. For example, the display data may include data that indicates which option depicted in the television content was selected by the viewer. In another example, the display data may include data that indicates how a general population interacted with interactive television content.

At 810, the display data is displayed on a television together with television content. For example, a set top box can receive television content and the display data and can process such data so that the television can effectively display the display data and the television content concurrently. In another example, the television itself may include functionality that allows the television to simultaneously display image data from two different sources (e.g., the third party service provider and a television broadcaster). The methodology 800 completes at 812.

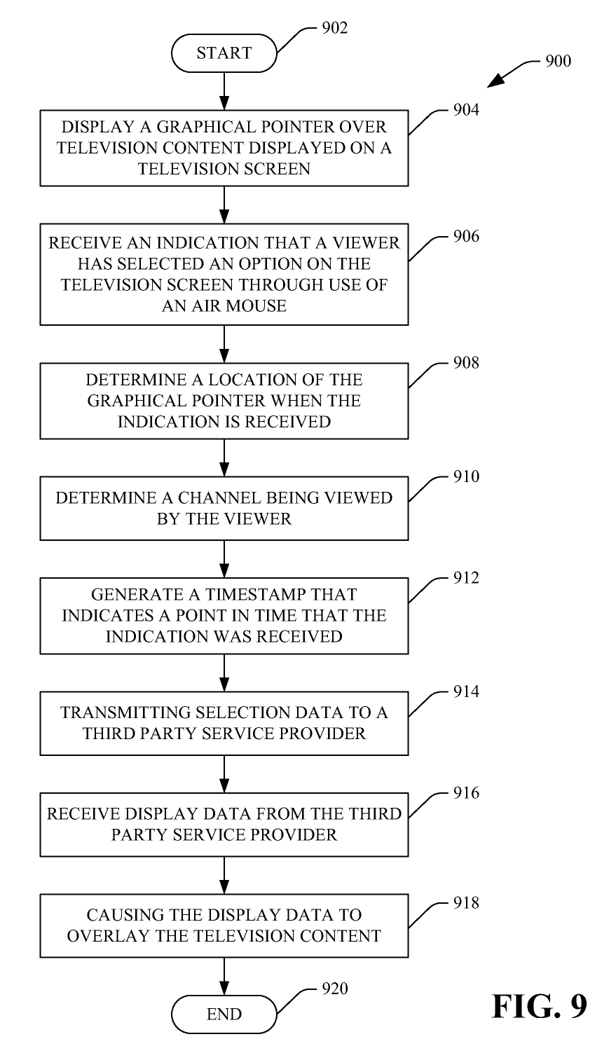

Now referring to FIG. 9, a methodology 900 that facilitates provision of interactive television content is illustrated. In an example, the methodology 900 may be implemented in a set top box that is placed in communication with a television. The methodology 900 starts at 902, and at 904 a graphical pointer is displayed over television content displayed on a television screen. For example, the graphical pointer can be displayed and positioned based at least in part upon commands from a viewer of the television content who is utilizing an air mouse. Thus, as the viewer moves the air mouse in three-dimensional space, the graphical pointer can be positioned in a corresponding manner over television content displayed on the television screen.

At 906, an indication is received that a viewer has utilized the air mouse to select one of a plurality of selectable options presented in the television content. For instance, the viewer can move the air mouse in three-dimensional space to position the graphical pointer over a graphical icon in the television content that represents a particular choice. The viewer may then depress a button on the air mouse to indicate that the viewer has selected the choice that corresponds to the position of the graphical pointer in the television content.

At 908, a location of the graphical pointer is determined, wherein the location is in the position of the graphical pointer when the indication is received at 906. For instance, when the set top box is placed in connection with the television, a coordinate system can be established and the location of the graphical pointer can be determined based upon what coordinates correspond to the graphical pointer when the viewer depressed a button on the air mouse.

At 910, a television channel being viewed by the viewer is determined (e.g., the television channel over which the television content is being broadcast). For instance, the viewer may explicitly indicate which channel is being viewed. In another example, a television signal may include data that identifies a channel being viewed. In another example, rather than determining a television channel being viewed, a program being viewed by the viewer can be ascertained.

At 912, a time stamp is generated that indicates a point in time that the indication was received at 906. For instance, a set top box can be synchronized with the third party service provider and/or a broadcaster, and the time stamp can be generated through use of a synchronized clock.

At 914, selection data is transmitted to a third party service provider, wherein the selection data comprises the determined location of the graphical pointer determined at 908, the channel being viewed by the viewer determined at 910, and the time stamp generated at 912. At 916, display data pertaining to a plurality of selectable options depicted in the television content is received from the third party service. For instance, the television content may display a plurality of selectable options, and the viewer may use the air mouse to select one of such options. The display data received at 916 can pertain to the selectable options and selection made by the viewer, a plurality of other viewers, a certain segment of viewers, etc.

At 918, the display data is caused to be displayed concurrently with television content. For instance, a set top box can be configured to receive television signals from a broadcaster and display data from the third party service provider, and may cause such data to be displayed concurrently (e.g., the display data received from the third party service provider can overlay television content received from the broadcaster.) The methodology 900 completes at 920.

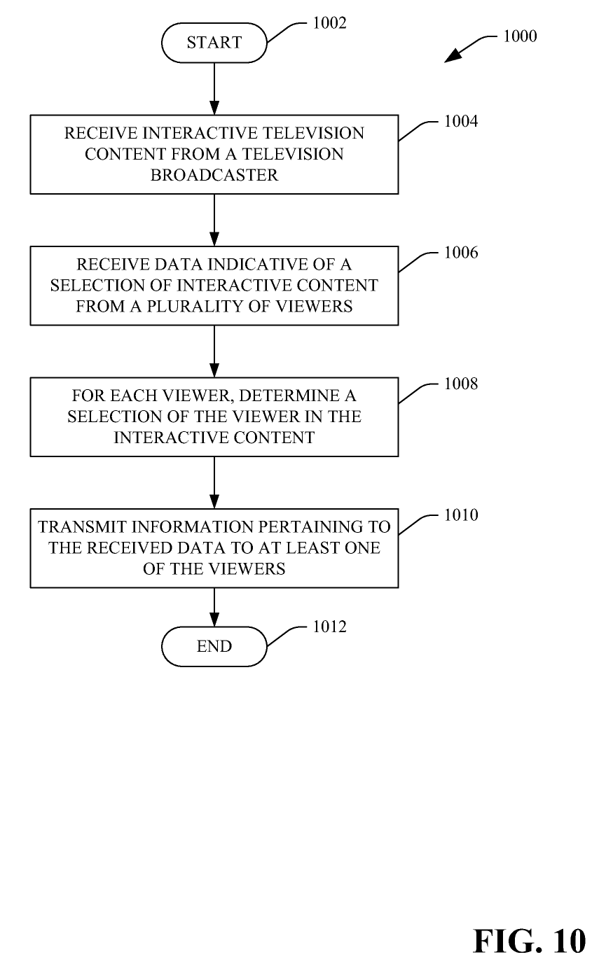

Referring now to FIG. 10, an example methodology 1000 that facilitates transmission of display data is illustrated. In an example, the methodology 1000 can be executed at a computing device managed by the third party service provider described herein. The methodology 1000 starts at 1002, and at 1004 interactive television content is received from a television broadcaster. The interactive television content may be a television signal, may be a synchronization signal that can be used to synchronize the broadcaster with a third party service provider, or other suitable interactive television content.

At 1006, data indicative of a selection of interactive content is received from a plurality of viewers. For example, television content may include a plurality of selectable possible answers in response to a proffered trivia question. A plurality of viewers may wish to interact with the television content and may use one of the mechanisms described herein to select one of the depicted options. These selections or data indicative thereof can be received at the third part service provider at 1006.

At 1008, a selection of each of the viewers is determined. For example, if Viewer A selected Option 1 and Viewer B selected Option 2, these selections can be determined at 1008. Such determination can be made based upon the data received at 1006.

At 1010, information pertaining to the data received at 1006 is transmitted to at least one of the viewers. For instance, this information may be display data that is to be displayed on the television of viewers and/or on portable electronic devices, such as portable telephones, of the viewer. The methodology 1000 completes at 1012.

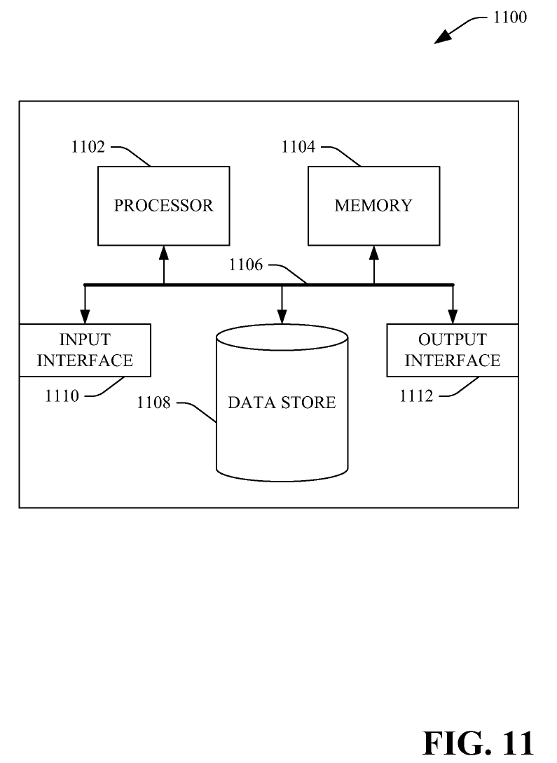

Now referring to FIG. 11, a high-level illustration of an example computing device 1100 that can be used in accordance with the systems and methodologies disclosed herein is illustrated. For instance, the computing device 1100 may be used in a system that supports interactive television. In another example, at least a portion of the computing device 1100 may be used in a set top box, a portable telephone, a third party service provider computing center, etc. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store viewer selections, interactive television content, data to be overlaid on television content, etc.

The computing device 1100 additionally includes a data store 1108 that is accessible by the processor 1102 by way of the system bus 1106. The data store 1108 may include executable instructions, television signals, display data, etc. The computing device 1100 also includes an input interface 1110 that allows external devices to communicate with the computing device 1100. For instance, the input interface 1110 may be used to receive instructions from an external computer device, an air mouse, a portable telephone, etc. The computing device 1100 also includes an output interface 1112 that interfaces the computing device 1100 with one or more external devices. For example, the computing device 1100 may display text, images, etc. by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A set top box that is placed in communication with a television comprising the following computer-executable components:
a receiver component that receives viewer-generated data from a portable electronic device, wherein the viewer-generated data is provided by a viewer responsive to display of interactive television content viewed by the viewer on the television;
a transmission component that transmits the viewer-generated data to a data repository managed by a third party service provider; and
a display component that causes interactive data pertaining to the viewer-generated data to be overlaid on the television content viewed by the viewer on the television.

2. The set top box of claim 1, wherein the receiver component receives the viewer-generated data from an air mouse, and wherein the display component overlays a mouse pointer on the television content viewed by the viewer on the television.

3. The set top box of claim 1, wherein the receiver component receives the viewer-generated data from a remote control pertaining to the set top box.

4. The set top box of claim 1 being included in a gaming console.

5. The set top box of claim 1, further comprising a synchronization component that is configured to synchronize a clock of the set top box with a clock corresponding to the television content.

6. The set top box of claim 5, further comprising a timestamp generator component that generates a timestamp responsive to the receiver component receiving the viewer-generated data and assigns the timestamp to the viewer-generated data, wherein the transmission component transmits the viewer-generated data and the timestamp to the data repository managed by the third party service.

7. The set top box of claim 6, further comprising a coordinate determiner component that determines coordinates on the television where the viewer selected an option presented in the television content, wherein the transmission component transmits the viewer-generated data and the timestamp to the data repository managed by the third party service.

8. The set top box of claim 1, further comprising an interface component that is configured to receive television audio/video input and overlay image data upon the received audio/video input.

9. The set top box of claim 8, wherein the interface component is configured to receive the television audio/video input by way of one of an S-video cable, a coaxial cable, a satellite signal, component cables, or an antenna signal.

10. The set top box of claim 1, wherein the display component is configured to cause the television to display viewer-generated content.

11. The set top box of claim 1, further comprising a channel identifier component that identifies a channel being viewed on the television, wherein the transmission component is configured to transmit the channel being viewed to the data repository.

12. The set top box of claim 1, further comprising a communications component that is configured to receive second viewer-generated data from a second viewer viewing the television content on a second television, wherein the display component is configured to overlay data upon the television content based at least in part upon the second viewer-generated data from the second viewer.

13. The set top box of claim 1, wherein the set top box is configured with an antenna that is configured to connect the set top box with a wireless network.

14. The set top box of claim 1, wherein the display component is configured to display content acquired from the Internet on the television.

15. A method comprising the following computer-executable acts:
receiving input from a viewer with respect to television content being viewed by the viewer on a television screen, wherein the input is received from the viewer by way of a portable electronic device;
transmitting the input from the viewer to a third party service provider, wherein the input is transmitted together with an identity of a channel to which the television is currently tuned;
receiving display data from the third party service provider pertaining to the input from the viewer; and
displaying the display data from the third party service provider on the television screen together with the television content.

16. The method of claim 15, wherein the portable electronic device is an air mouse.

17. The method of claim 15 configured for execution in a set top box.

18. The method of claim 15, wherein the input from the viewer is transmitted by way of an Internet connection to the third party service provider.

19. The method of claim 15, further comprising:
displaying a graphical pointer over the television content;
receiving a command from the viewer that indicates a selection of an option displayed in the television content;
determining a location of the graphical pointer over the television content when the command is received; and
transmitting the location to the third party service provider.

20. A computer readable medium comprising instructions that, when executed by a processor, cause the processor to perform the following acts:
displaying a graphical pointer over television content displayed on a television screen, wherein the graphical pointer is positioned in accordance with commands from a viewer that is utilizing an air mouse;
receiving an indication that the viewer has utilized the air mouse to select one of a plurality of selectable options presented in the television content;
determining a location of the graphical pointer when the indication is received;
determining a television channel over which the television content is being broadcast;
generating a time stamp that indicates a point in time that the indication was received;
transmitting selection data to a third party service provider, wherein the selection data comprises the determined location of the graphical pointer, the determined television channel, and the time stamp;
receiving display data pertaining to the plurality of selectable options from the third party service provider; and
causing the display data to be overlaid upon the television content.
